(19) United States
(12) Patent Application Publication
(10) Pub. No.: US 2025/0311014 A1
(43) Pub. Date: Oct. 2, 2025

(54) METHOD OF RACH TRANSMISSION AND USER EQUIPMENT

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/239,868

(22) Filed: Jun. 16, 2025

Related U.S. Application Data
(63) Continuation of application No. PCT/CN2024/072488, filed on Jan. 16, 2024.
(60) Provisional application No. 63/441,375, filed on Jan. 26, 2023.

(51) Int. Cl. H04W 74/0833; H04W 74/00

(52) U.S. Cl. CPC H04W 74/0833; H04W 74/006

(57) ABSTRACT

A method of random access channel (RACH) transmission, by a user equipment (UE) includes receiving, from a base station, a configuration of at least one candidate cell, receiving, from the base station, a control signaling indicating the UE to transmit a physical random access channel (PRACH) to a first candidate cell of the least one candidate cell, and transmitting a PRACH preamble to the first candidate cell based on the configuration of the at least one candidate cell and the control signaling.

### CROSS REFERENCE TO RELATED APPLICATION(S)

This application is a continuation of International Application No. PCT/CN2024/072488, filed Jan. 16, 2024, which claims priority to U.S. Provisional Application No. 63/441,375, filed Jan. 26, 2023, the entire disclosures of which are incorporated herein by reference.

### TECHNICAL FIELD

The present disclosure relates to the field of communication systems, and more particularly, to a method of random access channel (RACH) transmission and a user equipment (UE).

### BACKGROUND

The current physical downlink control channel (PDCCH) order physical random access channel (PRACH) cannot trigger a user equipment (UE) to transmit PRACH preamble to a non-serving cell. Therefore, when the UE is connected with a serving cell, the UE cannot send PRACH to the non-serving cell. The consequence is the UE would have to perform random access procedure to the non-serving cell when the UE is indicated to switch to that cell and latency of switching cell is enlarged.

Therefore, there is a need for apparatuses and methods of random access channel (RACH) transmission.

### SUMMARY

In a first aspect of the present disclosure, a method of random access channel (RACH) transmission, by a user equipment (UE), includes receiving, from a base station, a configuration of at least one candidate cell, receiving, from the base station, a control signaling indicating the UE to transmit a physical random access channel (PRACH) to a first candidate cell of the least one candidate cell, and transmitting a PRACH preamble to the first candidate cell based on the configuration of the at least one candidate cell and the control signaling.

In a second aspect of the present disclosure, a method of random access channel (RACH) transmission, by a base station, includes transmitting, to a user equipment (UE), a configuration of at least one candidate cell; transmitting a control signaling to indicate the UE to transmit a physical random access channel (PRACH) to a first candidate cell of the least one candidate cell; and receiving a PRACH preamble transmitted by the UE to measure uplink time of the UE.

In a third aspect of the present disclosure, a UE includes a memory, a transceiver, and a processor coupled to the memory and the transceiver. The UE is configured to perform the method in the first aspect.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a flowchart illustrating a method of random access channel (RACH) transmission.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of random access channel (RACH) transmission performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of random access channel (RACH) transmission performed by a base station according to an embodiment of the present disclosure.

FIG. 9 is a flowchart illustrating a method of random access channel (RACH) transmission performed by a base station according to an embodiment of the present disclosure.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

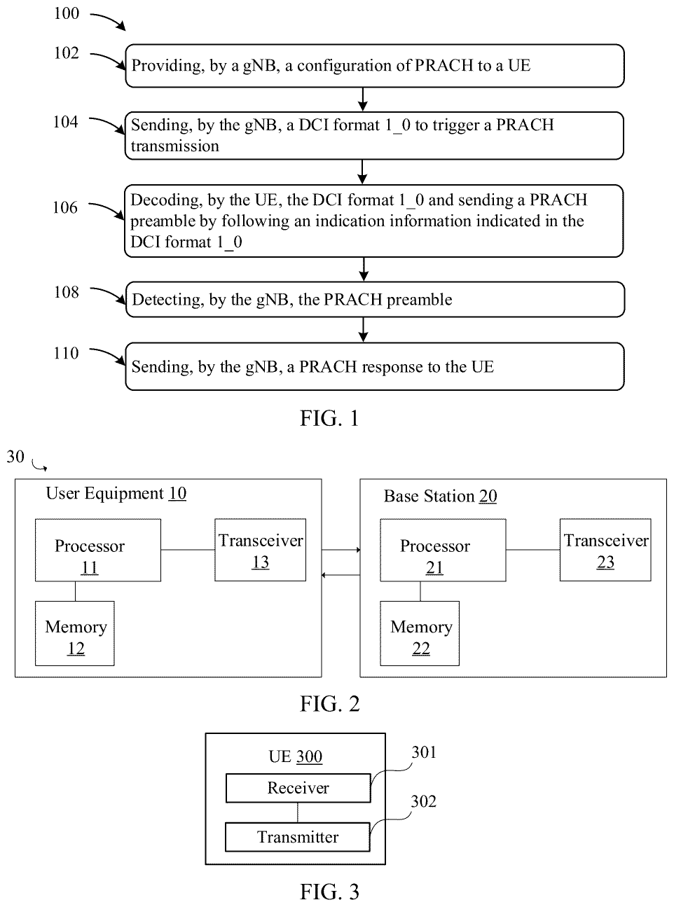

NR/5G system supports physical downlink control channel (PDCCH) order physical random access channel (PRACH) transmission. PDCCH order PRACH transmission is a mechanism by which a gNB can order a UE to initiate a PRACH transmission. One example use case for this mechanism is when the gNB finds the timing between the gNB and the UE needs further improvement, the gNB can order the UE to transmit a PRACH and then the gNB can measure the uplink timing. In NR/5G system, the gNB uses a downlink control information (DCI) format 0_1 to trigger the PDCCH order PRACH transmission. The basic procedure is illustrated in FIG. 1.

As illustrated in FIG. 1, a method 100 of random access channel (RACH) transmission includes: an operation 102, providing, by a gNB, a configuration of PRACH to a UE, an operation 104, sending, by the gNB, a DCI format 1_0 to trigger a PRACH transmission, an operation 106, decoding, by the UE, the DCI format 1_0 and sending a PRACH preamble by following an indication information indicated in the DCI format 1_0, an operation 108, detecting, by the gNB, the PRACH preamble, and an operation 110, sending, by the gNB, a PRACH response to the UE.

In details, FIG. 1 illustrates that, the gNB first provides the configuration of PRACH to the UE. When the gNB needs a PRACH for example to refine the timing, the gNB can send the DCI format 1_0 to trigger the UE to transmit the PRACH. When the UE receives the DCI format 1_0 for PDCCH order PRACH, the UE chooses the PRACH preamble by following the configuration provided by the gNB and then transmits the selected PRACH preamble in the corresponding PRACH resource. Then the gNB detects the PRACH preamble and after that, the gNB sends a response to the UE.

The DCI format 1_0 that the gNB uses to trigger PRACH transmission has the following fields:

Random access preamble index: that is used to indicate an index of a PRACH preamble that the UE chooses to transmit.

Uplink (UL)/supplemental UL (SUL) indicator: this field is used to indicate which uplink carrier in the cell to transmit the PRACH.

Synchronization signal/physical broadcast channel (SS/PBCH) index: this field indicates the SS/PBCH that is used to determine the RACH occasion for the PRACH transmission.

PRACH mask index: this field indicates the RACH occasion associated with the SS/PBCH indicated by the SS/PBCH index field for the PRACH transmission.

In NR/5G system, the PDCCH order PRACH can be used to trigger either a contention-based random-access procedure or contention-free random access procedure. The current PDCCH order PRACH cannot trigger the UE to transmit the PRACH preamble to a non-serving cell. Therefore, when the UE is connected with the serving cell, the UE cannot send PRACH to the non-serving cell. The consequence is the UE would have to perform random access procedure to the non-serving cell when the UE is indicated to switch to that cell and the latency of switching cell is enlarged.

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive, from the base station 20, a configuration of at least one candidate cell and a control signaling indicating the transceiver 13 to transmit a physical random access channel (PRACH) to a first candidate cell of the least one candidate cell, and the transceiver 13 is configured to transmit a PRACH preamble to the first candidate cell based on the configuration of the at least one candidate cell and the control signaling. This can solve issues in the prior art and other issues, reduce latency of inter-cell mobility, and/or improve a performance of RACH transmission.

In some embodiments, the transceiver 23 is configured to transmit, to the UE 10, a configuration of at least one candidate cell and a control signaling to indicate the UE 10 to transmit a physical random access channel (PRACH) to a first candidate cell of the least one candidate cell, and the transceiver 23 is configured to receive a PRACH preamble transmitted by the UE 10 to measure uplink time of the UE 10. This can solve issues in the prior art and other issues, reduce latency of inter-cell mobility, and/or improve a performance of RACH transmission.

FIG. 3 illustrates an example of a UE 300 according to an embodiment of the present application. The UE 300 is configured to implement some embodiments of the disclosure. Some embodiments of the disclosure may be implemented into the UE 300 using any suitably configured hardware and/or software. The UE 300 includes a receiver 301 and a transmitter 302. The receiver 301 is configured to receive, from a base station, a configuration of at least one candidate cell and a control signaling indicating the transmitter 302 to transmit a physical random access channel (PRACH) to a first candidate cell of the least one candidate cell. The transmitter 302 is configured to transmit a PRACH preamble to the first candidate cell based on the configuration of the at least one candidate cell and the control signaling. This can solve issues in the prior art and other issues, reduce latency of inter-cell mobility, and/or improve a performance of RACH transmission.

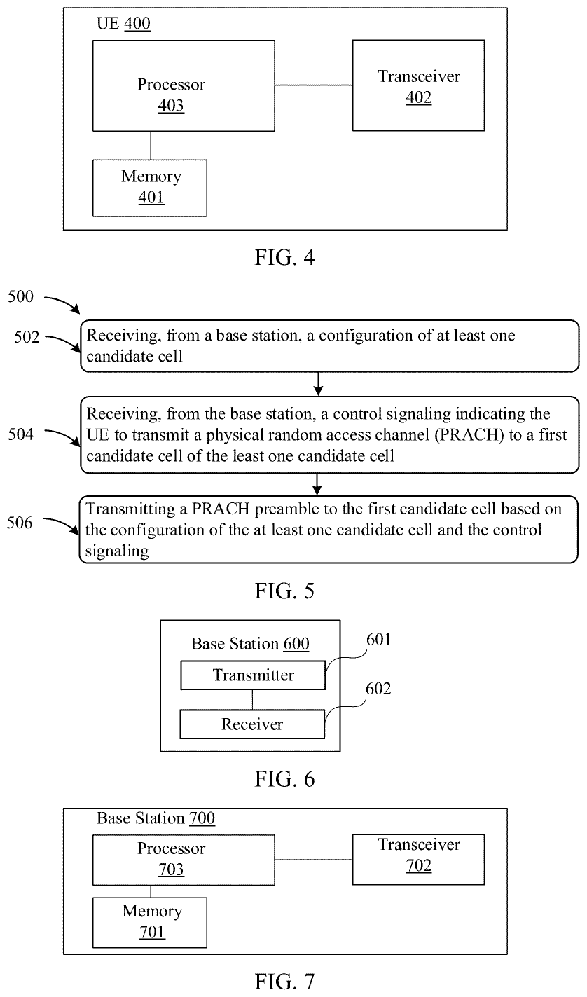

FIG. 4 illustrates an example of a UE 400 according to an embodiment of the present disclosure. The UE 400 is configured to implement some embodiments of the disclosure. Some embodiments of the disclosure may be implemented into the UE 400 using any suitably configured hardware and/or software. The UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 303 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the transceiver 402 is configured to receive, from a base station, a configuration of at least one candidate cell and a control signaling indicating the transceiver 402 to transmit a physical random access channel (PRACH) to a first candidate cell of the least one candidate cell, and the transceiver 402 is configured to transmit a PRACH preamble to the first candidate cell based on the configuration of the at least one candidate cell and the control signaling. This can solve issues in the prior art and other issues, reduce latency of inter-cell mobility, and/or improve a performance of RACH transmission.

FIG. 5 is an example of a method 500 of random access channel (RACH) transmission performed by a UE according to an embodiment of the present disclosure. The method 500 of random access channel (RACH) transmission performed by a UE is configured to implement some embodiments of the disclosure. Some embodiments of the disclosure may be implemented into the method 500 of random access channel (RACH) transmission performed by a UE using any suitably configured hardware and/or software. In some embodiments, the method 500 of random access channel (RACH) transmission performed by a UE includes: an operation 502, receiving, from a base station, a configuration of at least one candidate cell, an operation 504, receiving, from the base station, a control signaling indicating the UE to transmit a physical random access channel (PRACH) to a first candidate cell of the least one candidate cell, and an operation 506, transmitting a PRACH preamble to the first candidate cell based on the configuration of the at least one candidate cell and the control signaling. This can solve issues in the prior art and other issues, reduce latency of inter-cell mobility, and/or improve a performance of RACH transmission.

In some embodiments, the least one candidate cell includes a list of at least one physical cell identifier (ID) indicating at least one non-serving cell that is candidate for mobility. In some embodiments, the method further includes receiving a configuration of RACH for each of the least one candidate cell. In some embodiments, the method further includes being requested to receive a random access response (RAR) message corresponding to the PRACH preamble from the first candidate cell. In some embodiments, the method further includes receiving a timing advance value for uplink transmission towards the first candidate cell from the base station.

In some embodiments, the first control signaling indicates one or more of the following information: an indicator used to indicate the first candidate cell in the at least one candidate cell, an indicator of a synchronization signal/physical broadcast channel (SS/PBCH) of the first candidate cell, an indicator of a random-access preamble index, an uplink (UL)/supplemental UL (SUL) indicator used to indicate an UL carrier in the first candidate cell to transmit the PRACH, an indicator of a PRACH mask index, an indicator of physical cell ID (PCI) used to indicate a serving cell to transmit the PRACH, and an indicator used to indicate whether a RAR message is expected by the UE.

In some embodiments, the first control signaling is a downlink control information (DCI) format 1_0 with cyclic redundancy check (CRC) scrambled by a cell-radio network temporary identifier (C-RNTI). In some embodiments, when the UE is configured with the at least one candidate cell for lower-layer triggered mobility, the first control signaling contains a candidate cell indicator field. In some embodiments, the first control signaling is a DCI format 1_0 with CRC scrambled by a radio network temporary identifier (RNTI) configured for a physical downlink control channel (PDCCH) order RACH to the at least one candidate cell. In some embodiments, frequency domain resource assignment fields of the first control signaling are of all ones.

In some embodiments, being requested to receive the RAR message corresponding to the PRACH preamble from the first candidate cell includes wherein the UE does not expect to receive the RAR message if the PRACH preamble is transmitted to one candidate cell, not a serving cell. In some embodiments, being requested to receive the RAR message corresponding to the PRACH preamble from the first candidate cell includes wherein the UE expects to receive the RAR message corresponding to the PRACH preamble towards to the first candidate cell. In some embodiments, the RAR message includes a timing advance value of the first candidate cell. In some embodiments, the RAR message includes one indicator to indicate the first candidate cell. In some embodiments, being requested to receive the RAR message corresponding to the PRACH preamble from the first candidate cell includes wherein the UE is requested to receive the RAR message per a system configuration.

FIG. 6 illustrates an example of base station 600 according to an embodiment of the present application. The base station 600 is configured to implement some embodiments of the disclosure. Some embodiments of the disclosure may be implemented into the base station 600 using any suitably configured hardware and/or software. The base station 600 includes a transmitter 601 and a receiver 602. The transmitter 601 is configured to transmit, to a user equipment (UE), a configuration of at least one candidate cell and a control signaling to indicate the UE to transmit a physical random access channel (PRACH) to a first candidate cell of the least one candidate cell. The receiver 602 is configured to receive a PRACH preamble transmitted by the UE to measure uplink time of the UE. This can solve issues in the prior art and other issues, reduce latency of inter-cell mobility, and/or improve a performance of RACH transmission.

FIG. 7 illustrates an example of a base station 700 according to an embodiment of the present disclosure. The base station 700 is configured to implement some embodiments of the disclosure. Some embodiments of the disclosure may be implemented into the base station 700 using any suitably configured hardware and/or software. The base station 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the transceiver 702 is configured to transmit, to a user equipment (UE), a configuration of at least one candidate cell and a control signaling to indicate the UE to transmit a physical random access channel (PRACH) to a first candidate cell of the least one candidate cell, and the transceiver 702 is configured to receive a PRACH preamble transmitted by the UE to measure uplink time of the UE. This can solve issues in the prior art and other issues, reduce latency of inter-cell mobility, and/or improve a performance of RACH transmission.

FIG. 8 is an example of a method 800 of random access channel (RACH) transmission performed by a base station according to an embodiment of the present disclosure. The method 800 of random access channel (RACH) transmission performed by the base station is configured to implement some embodiments of the disclosure. Some embodiments of the disclosure may be implemented into the method 800 of random access channel (RACH) transmission performed by the base station using any suitably configured hardware and/or software. In some embodiments, the method 800 of random access channel (RACH) transmission performed by the base station includes: an operation 802, transmitting, to a user equipment (UE), a configuration of at least one candidate cell, an operation 804, transmitting a control signaling to indicate the UE to transmit a physical random access channel (PRACH) to a first candidate cell of the least one candidate cell, and an operation 806, receiving a PRACH preamble transmitted by the UE to measure uplink time of the UE. This can solve issues in the prior art and other issues, reduce latency of inter-cell mobility, and/or improve a performance of RACH transmission.

In some embodiments, the least one candidate cell includes a list of at least one physical cell identifier (ID) indicating at least one non-serving cell that is candidate for mobility. In some embodiments, the method further includes transmitting a configuration of RACH for each of the least one candidate cell. In some embodiments, the method further includes requesting the UE to receive a random access response (RAR) message corresponding to the PRACH preamble from the first candidate cell. In some embodiments, the method further includes determining a timing advance value for uplink transmission to the first candidate cell to the UE.

In some embodiments, the first control signaling indicates one or more of the following information: an indicator used to indicate the first candidate cell in the at least one candidate cell, an indicator of a synchronization signal/physical broadcast channel (SS/PBCH) of the first candidate cell, an indicator of a random-access preamble index, an uplink (UL)/supplemental UL (SUL) indicator used to indicate an UL carrier in the first candidate cell to transmit the PRACH, an indicator of a PRACH mask index, an indicator of physical cell ID (PCI) used to indicate a serving cell to transmit the PRACH, and an indicator used to indicate whether a RAR message is expected by the UE.

In some embodiments, the first control signaling is a downlink control information (DCI) format 1_0 with cyclic redundancy check (CRC) scrambled by a cell-radio network temporary identifier (C-RNTI). In some embodiments, when the UE is configured with the at least one candidate cell for lower-layer triggered mobility, the first control signaling contains a candidate cell indicator field. In some embodiments, the first control signaling is a DCI format 1_0 with CRC scrambled by a radio network temporary identifier (RNTI) configured for a physical downlink control channel (PDCCH) order RACH to the at least one candidate cell. In some embodiments, frequency domain resource assignment fields of the first control signaling are of all ones.

In some embodiments, requesting the UE to receive the RAR message corresponding to the PRACH preamble from the first candidate cell includes wherein the UE does not expect to receive the RAR message if the PRACH preamble is transmitted to one candidate cell, not a serving cell. In some embodiments, requesting the UE to receive the RAR message corresponding to the PRACH preamble from the first candidate cell includes wherein the UE expects to receive the RAR message corresponding to the PRACH preamble towards to the first candidate cell. In some embodiments, the RAR message includes a timing advance value of the first candidate cell. In some embodiments, the RAR message includes one indicator to indicate the first candidate cell. In some embodiments, being requested to receive the RAR message corresponding to the PRACH preamble from the first candidate cell includes wherein the UE is requested to receive the RAR message per a system configuration.

### Exemplary Technical Solutions:

In some embodiments, a serving gNB can provide a first list of candidate cell(s) to a UE, where the list of candidate cell(s) can be a list of physical cell ID(s) that indicate a non-serving cell that are candidate for mobility. The gNB can also provide a RACH configuration for each cell contained in the first list of candidate cell(s). In other word, for one cell contained in the first list of candidate cell(s), there is one configuration of RACH transmission. Then, the gNB can indicate a UE to transmit a PRACH towards to a first non-serving cell contained in the first list of candidate cell(s). The gNB can provide the configuration of PRACH of one or more non-serving cells to the UE. The gNB can send a first control signaling, for example a first DCI to indicate the UE to transmit PRACH to a first non-serving cell.

In some embodiments, the first control signaling can indicate one or more of the following information:

An indicator used to indicate a first non-serving cell in the first list of candidate cell, which the UE is indicated to transmit a PRACH preamble to.

An indicator of a SS/PBCH of a cell. This field can indicate a SS/PBCH of a non-serving cell. The UE can be requested to use this indicated SS/PBCH to determine RACH occasion for the PRACH transmission.

An indicator of a random-access preamble index. This field can indicate one PRACH preamble for the UE to transmit.

An indicator of a PRACH mask index. This field can be used to indicate the RACH occasion for PRACH transmission.

An indicator used to indicate whether a random access response (RAR) message is expected by the UE.

In some embodiments, when receiving the first control signaling, the UE can be requested to transmit a PRACH preamble in a determined PRACH occasion towards to the first non-serving cell. In some examples, the UE can be indicated to a RACH occasion for PRACH transmission based on one indicated SS/PBCH of the first non-serving cell. The UE can be requested to determine the uplink transmission configuration for transmitting PRACH preamble based on the indicated SS/PBCH of the first non-serving cell, where the uplink transmission configuration can include a spatial transmit filter and/or uplink transmit power. In some embodiments, when receiving the PRACH preamble transmission from the UE, the gNB can determine a timing advance value for uplink transmission towards the first non-serving cell. The gNB can indicate the timing advance for uplink transmission to the first non-serving cell to the UE.

In some embodiments, the first DCI can be designed according one or more of the following alternatives:
First alternative (Alt1): The first DCI can be a DCI format 1_0 with CRC scrambled by C-RNTI and frequency domain resource assignment fields are of all ones. When the UE is configured with candidate cell(s) for lower-layer triggered mobility, this DCI format can contain one field of candidate cell indicator.
Second alternative (Alt2): The first DCI can be a DCI format 1_0 with CRC scrambled by a RNTI configured for PDCCH order RACH to candidate cell, for example, which can be called C-LTM-RNTI. In the first DCI, frequency domain resource assignment fields are of all ones.

In some embodiments, after sending the RACH preamble, the UE can be requested to receive the RAR message as configured or pre-defined according to one or more of the following alternatives:
Alt1: The UE does not expect to receive a RAR message if the RACH preamble is transmitted to one candidate cell, not the serving cell.
Alt2: The UE can expect to receive a RAR message corresponding to the RACH preamble towards to a first candidate cell. The RAR message can include a timing advance (TA) value of the first candidate cell. The RAR message can also include one indicator to indicate the first candidate cell.
Third alternative (Alt3): The UE can be requested to receive the RAR message per system configuration. For example, the system can use a radio resource control (RRC) signaling to indicate the UE whether the UE expects to receive the RAR message after sending the RACH preamble to one first candidate cell.

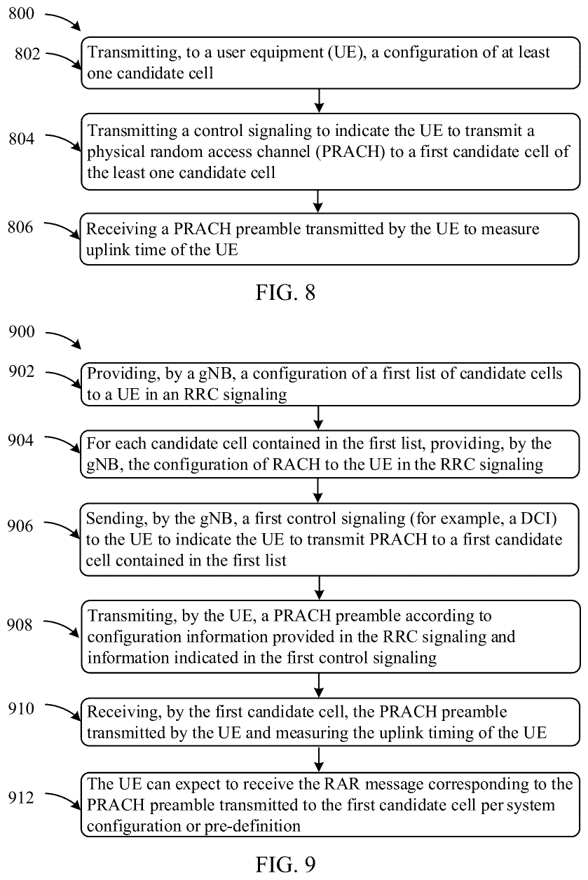

FIG. 9 illustrates a procedure of RACH towards a non-serving cell according to the methods proposed in some embodiments of this disclosure. FIG. 9 illustrates that, a method 900 of RACH transmission is configured to implement some embodiments of the disclosure. Some embodiments of the disclosure may be implemented into the method 900 of RACH transmission using any suitably configured hardware and/or software. In some embodiments, the method 900 of RACH transmission includes: an operation 902, providing, by a gNB, a configuration of a first list of candidate cells to a UE in an RRC signaling, an operation 904, for each candidate cell contained in the first list, providing, by the gNB, the configuration of RACH to the UE in the RRC signaling, an operation 906, sending, by the gNB, a first control signaling (for example, a DCI) to the UE to indicate the UE to transmit PRACH to a first candidate cell contained in the first list, an operation 908, transmitting, by the UE, a PRACH preamble according to configuration information provided in the RRC signaling and information indicated in the first control signaling, an operation 910, receiving, by the first candidate cell, the PRACH preamble transmitted by the UE and measuring the uplink timing of the UE, and an operation 902, wherein the UE can expect to receive the RAR message corresponding to the PRACH preamble transmitted to the first candidate cell per system configuration or pre-definition.

In a first illustrative example method, the gNB can provide a list of candidate cell(s) for mobility to the UE and the gNB can also provide the RACH configuration for each of the candidate cell. The gNB can send one DCI format 1_0 to trigger the UE to transmit PRACH preamble towards to a first candidate cell. The UE can be provided with one RNTI for PDCCH order RACH to candidate cell, which, for example, can be called C-LTM-RNTI. When the gNB sends one DCI format 1_0 to the UE, if the CRC of the DCI format 1_0 is scrambled by C-LTM-RNTI and the “Frequency domain resource assignment” field are of all ones, this DCI format is for random access procedure initiated by a PDCCH order with all the following fields sets:

An indicator used to indicate one cell in the first list of candidate cells. This field can indicate a non-serving cell in the first list of candidate cells to which the UE is indicated to transmit a PRACH preamble. In some examples, the size of this field can be zero if the UE is not configured with L1/L2 triggered mobility. In some examples, the size of this field can be N bits if the UE is configured with L1/L2 triggered mobility. In some examples, the size of this field can be N bits if the UE is provided with the first list of candidate cells and the size of N=┌log₂(L+1)┐, where L is the number of cells configured in the first list of candidate cells.

An indicator of a SS/PBCH of a cell. This field can indicate a SS/PBCH of a non-serving cell. The UE can be requested to use this indicated SS/PBCH to determine RACH occasion for the PRACH transmission.

An indicator of a random-access preamble index. This field can indicate one PRACH preamble for the UE to transmit.

An indicator of a PRACH mask index. This field can be used to indicate the RACH occasion for PRACH transmission.

An indicator to indicate whether the UE expects a RAR message after sending the PRACH preamble.

In a second illustrative example method, the gNB can provide a list of candidate cell(s) for mobility to the UE and the gNB can also provide the RACH resource configuration for each of the candidate cell. The gNB can send one DCI format 1_0 to trigger the UE to transmit PRACH preamble towards to a first candidate cell or the serving cell. In some examples, the gNB can provide one RRC signaling to indicate the UE whether the UE supports the PRACH transmission towards candidate cell. The UE can be requested to expect to receive DCI format 1_0 to trigger a random-access procedure initiated by a PDCCH order to a candidate cell if one or more of the following conditions are met:

If the gNB explicitly configures the UE to support transmitting random access procedure initiated by a PDCCH order to a candidate cell.

If the gNB provides a list of candidate cell(s) for mobility.

If the gNB provides a RACH resource configuration for one or more candidate cell(s) to the UE.

When the UE is indicated to support random access procedure initiated by PDCCH order to a candidate cell, the UE can expect to receive one DCI format 1_0 with CRC scrambled by the C-RNTI and frequency domain resource assignment filed set to all ones to trigger random access procedure initiated by a PDCCH order to a candidate cells, and the DCI format can have the following DCI fields:

An indicator used to indicate one cell in the first list of candidate cells. This field can indicate a non-serving cell in the first list of candidate cells to which the UE is indicated to transmit a PRACH preamble. In some examples, the size of this field can be zero if the UE is not configured with L1/L2 triggered mobility. In some examples, the size of this field can be N bits if the UE is configured with L1/L2 triggered mobility. In some examples, the size of this field can be N bits if the UE is provided with the first list of candidate cells and the size of N=┌log₂(L+1)┐, where L is the number of cells configured in the first list of candidate cells.

An indicator of a SS/PBCH of a cell. This field can indicate a SS/PBCH of a non-serving cell. The UE can be requested to use this indicated SS/PBCH to determine RACH occasion for the PRACH transmission.

An indicator of a random-access preamble index. This field can indicate one PRACH preamble for the UE to transmit.

An indicator of a PRACH mask index. This field can be used to indicate the RACH occasion for PRACH transmission.

An indicator to indicate whether the UE shall expect a RAR message after sending the PRACH preamble.

In a third illustrative example method, the gNB can provide a list of candidate cell(s) for mobility to the UE and the gNB can also provide the RACH resource configuration for each of the candidate cell. The gNB can send one DCI format 1_0 to trigger the UE to transmit PRACH preamble towards to a first candidate cell or the serving cell. In some examples, the gNB can provide one RRC signalling to indicate the UE whether the UE shall support PRACH transmission towards candidate cell. The UE can be requested to expect to receive DCI format 1_0 to trigger a random-access procedure initiated by a PDCCH order to a candidate cell if one or more of the following conditions are met:
If the gNB explicitly configures the UE to support transmitting random access procedure initiated by a PDCCH order to a candidate cell.
If the gNB provides a list of candidate cell(s) for mobility.
If the gNB provides RACH resource configuration for one or more candidate cell(s) to the UE.

When the UE is indicated to support random access procedure initiated by PDCCH order to a candidate cell, the UE can expect to receive one DCI format 1_0 with CRC scrambled by the C-RNTI and the frequency domain resource assignment filed set to all ones to trigger random access procedure initiated by a PDCCH order to a candidate cells, and the DCI format can have the following DCI fields:
Random Access Preamble index: in some examples, it can be 6 bits. It can indicate one RACH preamble index.
UL/SUL indicator: in some examples, this field can be 1 bit. This field indicates which UL carrier in the cell to transmit the PRACH.
SS/PBCH index: this field can be 6 bits. This field can indicate one SS/PBCH of the serving cell indicated by the field of indicator of physical cell ID that shall be used to determine the RACH occasion for the PRACH transmission.
PRACH Mask index. This field can be 4 bits. This field can indicate the RACH occasion associated with the SS/PBCH indicated by SS/PBCH index field for the PRACH transmission.
One indicator of physical cell ID (PCI): this field indicates which serving cell to transmit the PRACH. In one example, this field has 0 bit for UEs not configured with L1/L2 triggered mobility. In some examples, this field has 0 bit for UEs not configured with a first list of candidate cells for L1/L2 triggered mobility. In some examples, this field has ┌log₂(L+1)┐ bits for UE configured with a first list of candidate cells where the first list contains L candidate cells. In some examples, one DCI code point of this field can indicate the UE to transmit PRACH preamble to the serving cell. For example, the DCI code point with all 0s indicate the UE to transmit PRACH preamble to the serving cell and the DCI code point 001 indicate the UE to transmit PRACH preamble to the non-serving cell of the first entry in the first list of candidate cells.
One indicator of RAR: this field indicates whether the UE can expect RAR message after sending PRACH preamble. In some examples, this field has 0 bit for UEs not configured with a list of candidate cells for L1/L2 triggered mobility. In some examples, this field has 0 bit for UEs not configured with L1/L2 triggered mobility. In some examples, this field has 1 bit for UEs configured with a list of candidate cells for L1/L2 triggered mobility.

The proposed method can reduce the latency of inter-cell mobility. Before switching to the target cell (which is a non-serving cell), the serving cell gNB can trigger the UE to transmit PRACH to the target cell, so that the uplink timing to that non-serving cell can be obtained before the UE switches to the target cell.

Commercial interests for some embodiments are as follows. 1. Solve issues in the prior art and other issues. 2. Reduce latency of inter-cell mobility. 3. Improve a performance of RACH transmission. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of random access channel (RACH) transmission are considered for standardizing.

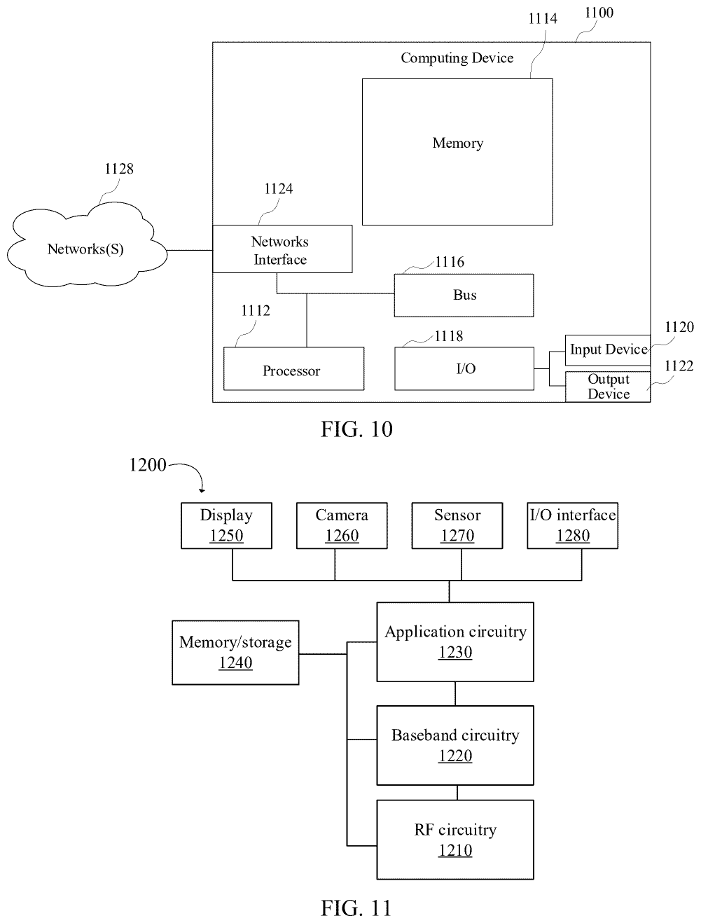

FIG. 10 is an example of a computing device 1100 according to an embodiment of the present disclosure. Any suitable computing device can be used for performing the operations described herein. For example, FIG. 10 illustrates an example of the computing device 1100 that can implement some embodiments of FIG. 2 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 2 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 2 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 2 to FIG. 9 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of random access channel (RACH) transmission, by a user equipment (UE), comprising:
receiving, from a base station, a configuration of at least one candidate cell;
receiving, from the base station, a control signaling indicating the UE to transmit a physical random access channel (PRACH) to a first candidate cell of the least one candidate cell; and
transmitting a PRACH preamble to the first candidate cell based on the configuration of the at least one candidate cell and the control signaling.

2. The method of claim 1, wherein the least one candidate cell comprises a list of at least one physical cell identifier (ID) indicating at least one non-serving cell that is candidate for mobility.

3. The method of claim 1, further comprising receiving a configuration of RACH for each of the least one candidate cell.

4. The method of claim 1, further comprising being requested to receive a random access response (RAR) message corresponding to the PRACH preamble from the first candidate cell.

5. The method of claim 1, further comprising receiving a timing advance value for uplink transmission towards the first candidate cell from the base station.

6. The method of claim 1, wherein the first control signaling indicates one or more of the following information:
an indicator used to indicate the first candidate cell in the at least one candidate cell;
an indicator of a synchronization signal/physical broadcast channel (SS/PBCH) of the first candidate cell;
an indicator of a random-access preamble index;
an uplink (UL)/supplemental UL (SUL) indicator used to indicate an UL carrier in the first candidate cell to transmit the PRACH;
an indicator of a PRACH mask index;
an indicator of physical cell ID (PCI) used to indicate a serving cell to transmit the PRACH; and
an indicator used to indicate whether a RAR message is expected by the UE.

7. The method of claim 1, wherein the first control signaling is a downlink control information (DCI) format 1_0 with cyclic redundancy check (CRC) scrambled by a cell-radio network temporary identifier (C-RNTI).

8. The method of claim 7, wherein when the UE is configured with the at least one candidate cell for lower-layer triggered mobility, the first control signaling contains a candidate cell indicator field.

9. The method of claim 1, wherein the first control signaling is a DCI format 1_0 with CRC scrambled by a radio network temporary identifier (RNTI) configured for a physical downlink control channel (PDCCH) order RACH to the at least one candidate cell.

10. The method of claim 7, wherein frequency domain resource assignment fields of the first control signaling are of all ones.

11. The method of claim 4, wherein being requested to receive the RAR message corresponding to the PRACH preamble from the first candidate cell comprises wherein the UE does not expect to receive the RAR message if the PRACH preamble is transmitted to one candidate cell, not a serving cell.

12. The method of claim 4, wherein being requested to receive the RAR message corresponding to the PRACH preamble from the first candidate cell comprises wherein the UE expects to receive the RAR message corresponding to the PRACH preamble towards to the first candidate cell.

13. The method of claim 12, wherein the RAR message comprises a timing advance value of the first candidate cell.

14. The method of claim 12, wherein the RAR message comprises one indicator to indicate the first candidate cell.

15. The method of claim 4, wherein being requested to receive the RAR message corresponding to the PRACH preamble from the first candidate cell comprises wherein the UE is requested to receive the RAR message per a system configuration.

16. A method of random access channel (RACH) transmission, by a base station, comprising:
transmitting, to a user equipment (UE), a configuration of at least one candidate cell;
transmitting a control signaling to indicate the UE to transmit a physical random access channel (PRACH) to a first candidate cell of the least one candidate cell; and
receiving a PRACH preamble transmitted by the UE to measure uplink time of the UE.

17. The method of claim 16, wherein the least one candidate cell comprises a list of at least one physical cell identifier (ID) indicating at least one non-serving cell that is candidate for mobility.

18. The method of claim 16, further comprising transmitting a configuration of RACH for each of the least one candidate cell.

19. The method of claim 16, further comprising requesting the UE to receive a random access response (RAR) message corresponding to the PRACH preamble from the first candidate cell.

20. A user equipment (UE), comprising:
a memory;
a transceiver, and
a processor coupled to the memory and the transceiver,
wherein the UE is configured to:
receive from a base station, a configuration of at least one candidate cell;
receive from the base station, a control signaling indicating the UE to transmit a physical random access channel (PRACH) to a first candidate cell of the least one candidate cell; and
transmit a PRACH preamble to the first candidate cell based on the configuration of the at least one candidate cell and the control signaling.
